(19) United States
(12) Patent Application Publication
(10) Pub. No.: US 2011/0295883 A1
(43) Pub. Date: Dec. 1, 2011

(54) TPEG CLIENT DEVICE AND METHOD

(75) Inventors: Stefan Posner, Munich (DE); Juergen Welscher, Markt Schwaben (DE)

(73) Assignee: Harman Becker Automotive Systems GmbH, Karlsbad (DE)

(21) Appl. No.: 13/108,688

(22) Filed: May 16, 2011

(30) Foreign Application Priority Data
May 28, 2010 (EP) 10 164 217.1

(51) Int. Cl. G06F 17/30

(52) U.S. Cl. 707/769; 707/802; 707/E17.014; 707/E17.005; 707/E17.044

(57) ABSTRACT

An electronic device configured to operate as a TPEG client is provided. The electronic device includes an interface adapted to receive TPEG messages comprising TPEG event codes. A relational database is stored in memory of the electronic device. The relational database includes at least one relation with a plurality of records, each record associating a TPEG event code with an event text.

### RELATED APPLICATIONS

This application claims priority of European Patent Application Serial Number 10 164 217.1, filed on May 28, 2010, titled TPEG CLIENT DEVICE, which application is incorporated in its entirety by reference in this application.

### BACKGROUND OF THE INVENTION

1. Field of the Invention

The invention relates to an electronic device configured to operate as a Transport Protocol Experts Group (“TPEG”) client and further to a method of operating such a device.

2. Related Art

Navigation and in particular the orientation when driving a vehicle is facilitated by the use of navigation devices that generally use a global positioning system (GPS) to determine a current position and provided together with routing information to a user. Navigation devices usually include map data such that the route to a destination entered by the user or the driver can be calculated. Map information stored on a conventional navigation device is only static, so that when a particular road becomes impassable or blocked, e.g., due to an accident or road construction, this is not considered in the route determination.

This drawback was overcome by introducing the traffic message channel (TMC), by means of which current traffic and travel information (TTI) can be delivered to the navigation device and the driver. The information on the TMC is generally digitally coded and transmitted by a conventional FM radio broadcast. A TMC message comprises a location code that has to be translated into a location on the road network by location code tables at the receiving device.

An improvement was achieved by the development of the TPEG tool kit and specifications by the transport protocol experts group (TPEG) that enable the transmission of language independent multi-modal traffic and travel information. In contrast to TMC, TPEG allows use of further location referencing methods besides TMC, thus enabling, for example, more precise referencing as well as on-the-fly referencing (not needing any pre-coded location codes anymore). TPEG, being bearer independent by design, allows messages to be delivered by a range of transmission systems, such as digital audio broadcasting (DAB), digital video broadcasting (DVB), digital multimedia broadcasting (DMB), and via the Internet. In addition, TPEG is not limited to transmitting only event codes in the form of TMC event codes, but provides for a vast set of TPEG applications, using a dedicated TPEG message set to inform the user not only about traffic incidents, but also about detailed traffic flow of complete road networks, parking facilities, fuel price information, etc.

For displaying a text message at a TPEG client device, a TPEG event code that is transmitted with a TPEG message needs to be decoded at the client device. A TPEG client is adapted to receive and decode TPEG messages. For this purpose, TPEG client devices are manufactured with embedded TPEG tables installed on the device. These pre-installed TPEG tables are generally appropriate to the market in which the respective TPEG client devices are sold, and comprise the TPEG event codes and the respective words only up to the time of their manufacture.

One disadvantage is that these tables cannot be expanded or updated if they are part of the client software. In view of the free circulation of goods throughout the different parts of the world, the TPEG client device may need to be operated in a language different to the one originally installed. Embedding the tables in the software of the client device prevents the use of new languages resulting in conventional TPEG systems being inflexible.

Accordingly, a need exists to obviate at least some of the drawbacks mentioned above, and to improve the flexibility of TPEG message decoding.

### SUMMARY

An electronic device configured to operate as a TPEG client is provided. The electronic device includes an interface adapted to receive TPEG messages comprising TPEG event codes. A relational database is stored in memory of the electronic device. The relational database includes at least one relation with a plurality of records, each record associating a TPEG event code with an event text.

A method of operating an electronic device configured to operate as a TPEG client is also provided. The electronic device includes an interface for receiving TPEG messages and a relational database having at least one relation with a plurality of records. Each record associates a TPEG event code with an event text. In the method, a TPEG message having a TPEG event code is received on the interface. The electronic device then accesses, in the relational database, a record for the TPEG event code corresponding to the event code in the received TPEG message. The event text associated with the TPEG event code is retrieved from the accessed record of the relational database.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic drawing illustrating a TPEG client device according to one example of an implementation of the invention.

FIG. 2 schematically illustrates a relation of a relational database according to one example of an implementation.

FIG. 3 schematically illustrates a relation of a relational database according to another example of an implementation of the invention.

FIG. 4A schematically illustrates a relation of a relational database according to yet another example of an implementation of the invention.

FIG. 4B schematically illustrates a relation of a relational database according to an example of an implementation including entries having the same event codes for different event types and different TPEG applications.

FIG. 5 is a flow-diagram illustrating one example of a method for assembling and displaying text messages.

FIG. 6 is a flow-diagram illustrating one example of a method for updating a relational database.

### DETAILED DESCRIPTION

In the following, various examples of implementations will be described in detail with reference to the accompanying drawings. It is to be understood that the following descriptions are given only for the purpose of illustration and are not to be taken in a limiting sense. The drawings are to be regarded as being schematic representations only and elements in the drawings are not necessarily to scale with each other. The physical or functional blocks or units shown in the drawings are not necessarily implemented as physically separate units, but the blocks or units shown described may be implemented as separate units, circuits, chips or circuit elements, or may as well be implemented in a common circuit, chip, circuit element or unit.

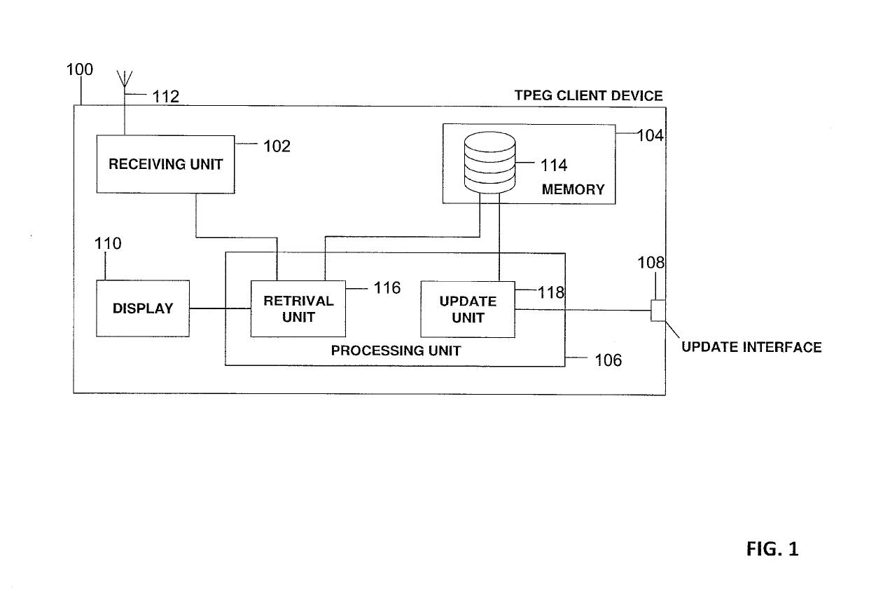

FIG. 1 shows a schematic block diagram of a TPEG client device 100 according to one example of an implementation of the invention. The TPEG client device 100 is adapted to operate as a TPEG client able to receive and interpret TPEG messages. The information found in received TPEG messages is processed by TPEG client device 100 and is presented to a user of the device.

TPEG client device 100 has a receiver unit 102 adapted to provide an interface for receiving TPEG messages. The delivery of TPEG messages generally occurs by means of broadcast service delivery. Receiver unit 102 may for example be a digital audio broadcasting (DAB) receiver receiving DAB broadcasts by means of antenna 112, to which it is coupled. Receiving unit 102 may accordingly be configured to extract a TPEG message from a received DAB broadcast. Other implementations of the receiving unit 102 may be implemented, e.g., as a DMB receiver, a DVB receiver or a wired or wireless network interface for receiving TPEG messages via the Internet.

TPEG client device 100 further includes a processing unit 106 which is adapted to process received TPEG messages. Processing unit 106 controls the operation of the TPEG client device 100 according to control programs stored in memory 104. Processing unit 106 may be implemented as a single or multiple microprocessors in the form of a general purpose or special purpose microprocessor or one or more digital signal processors or application specific integrated circuits. The memory 104 may comprise all forms of memory, such as random access memory (RAM), flash memory or a hard drive. Some of these types of memory may be removable from the device 100, e.g., a flash memory card or like.

Processing unit 106 includes the functional units 116 and 118, which may for example be implemented as software code portions running on the processing unit 106. The retrieval unit 116 is adapted to analyse an incoming TPEG message for TPEG event codes found in the message. Upon finding such a TPEG event code, retrieval unit 116 retrieves a corresponding event text from database 114 stored in memory 104.

Database 114 is a relational database storing one or more relations for associating TPEG event codes with event texts. Different relations can be included in the relational database 114 for different types of TPEG event codes. As an example, a relation may be provided for effect codes, for cause codes, for severity codes, for a restriction type code and the like. While an effect code may for example indicate “slow traffic,” “heavy traffic,” or “queuing one or traffic,” a cause code may indicate “slippery road,” “road works,” or “traffic congestion.” In a relational database, the different relations may be stored in tables and it may be possible to sort the tables based on any field contained in a table. A relational database may contain several tables, each table containing a column or several columns that other tables can key on to gather information from that table. The relation may be a two-dimensional table with a unique set of rows and columns. The column relates one record to the other, a single record being stored in the table as a row.

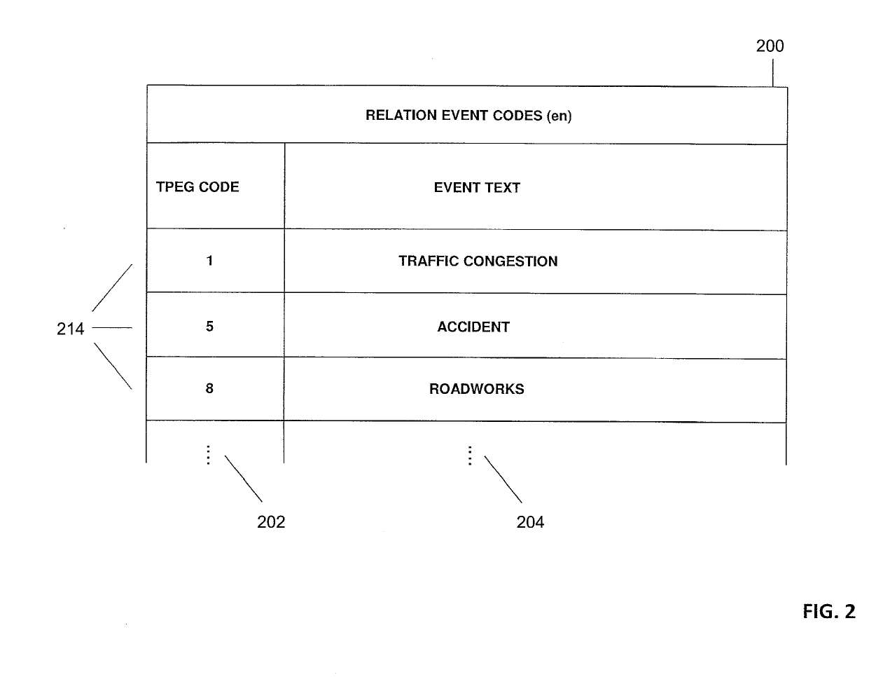

FIG. 2 illustrates an example of a relation that may be stored in database 114, for event codes in form of cause codes. The relation 200 includes a first attribute 202 defining the TPEG event code and a second attribute 204 defining the corresponding event text. The records 214 of the relation 200 are shown in FIG. 2 as rows of the table. Such a record may also be termed tuple or relationship as it associates or relates certain attributes with each other. In the relation 200, each record associates a TPEG event code with an event text. By the appropriate query, a particular record 214 can be found, which is, for example, identified by the TPEG event code 202 as a primary key. In the record, the event text attribute 204 can then be identified, for example by a query making use of the “project” operation. Accordingly, with a given TPEG event code, the associated event text can be retrieved from the relation 200.

The event text is generally a character string describing a traffic event. It can be stored in a plain text representation in the relational database 114, e.g., in the ASCII or the Unicode format, yet it may also be encoded in the binary format.

It should be clear that the relation 200 may include further attributes, for example, attributes comprising foreign keys that link a particular record to another relation, such as a sub cause relation, or an attribute that defines a unique primary key for each entry 214 (surrogate key), which may be used instead of the TPEG event code.

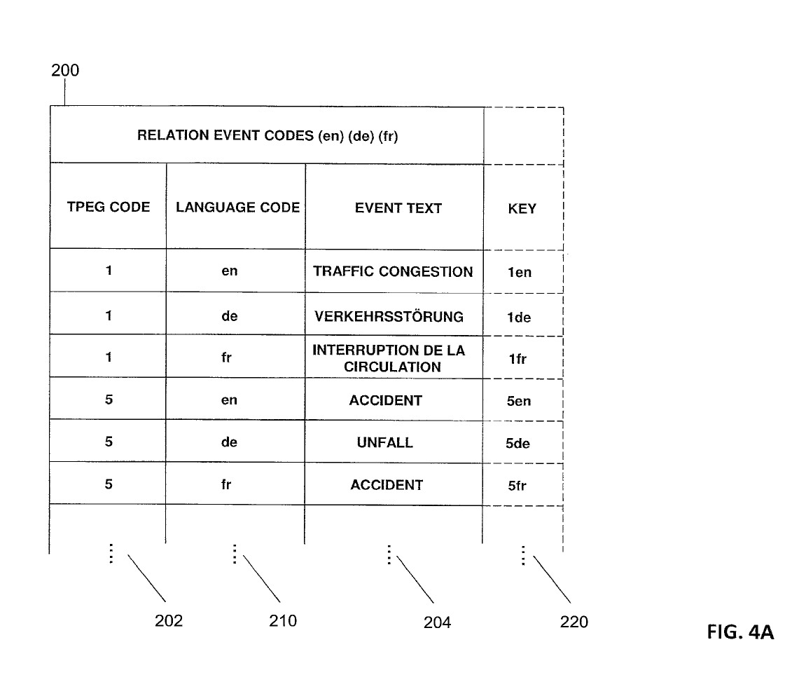

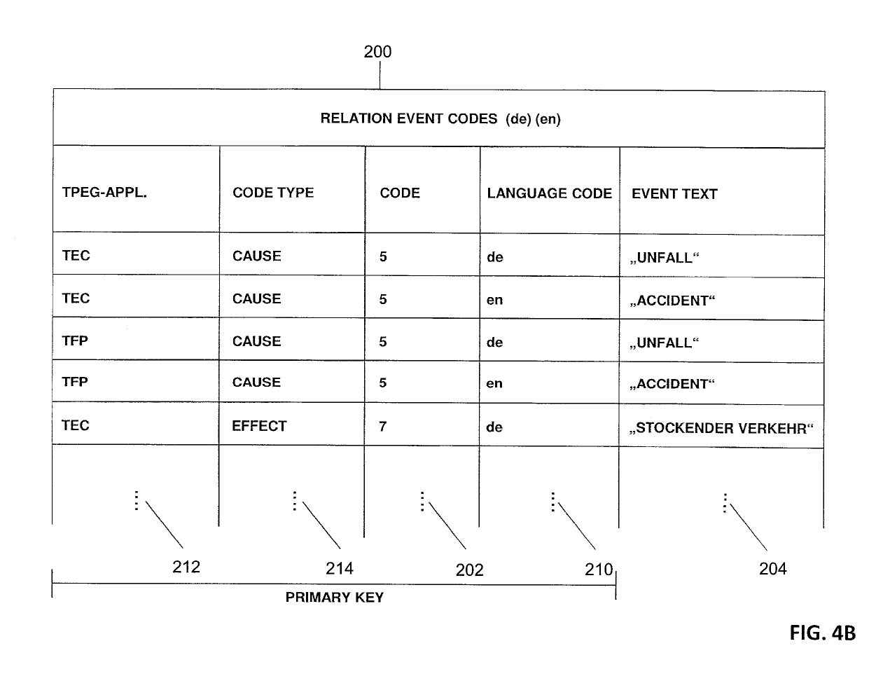

In particular, the same TPEG event codes may be used for different event types, different TPEG applications or the like, and may be stored in the same relation. The relation 200 may include corresponding attributes, as illustrated in FIG. 4B. The TPEG event code is then no longer unique. An event text may thus be addressed by not only specifying the TPEG event code, but also the code type (e.g., cause code, effect code, . . . ) and the TPEG-Application (e.g., Traffic Flow and Prediction (TFP), Traffic Event Compact (TEC), . . . ). These attributes can be used to define a unique primary key for retrieving a particular event text from the relation 200 of the relational database. Such an implementation can be chosen for any of the relations illustrated with respect to FIGS. 2, 3 and 4A. For reasons of clarity, these additional attributes are not shown in the corresponding figures. In other examples, individual relations may be provided in database 114 for different event types and/or different TPEG applications.

Relation 200 is provided for the English language (en). Database 114 may include further similar relations for other languages (not shown). Such further relations can include the same TPEG event codes as the relation 200 and the corresponding event texts in the respective additional language. The relation can then be identified as being a relation for a particular language, as indicated with (en) for the relation 200 of FIG. 2.

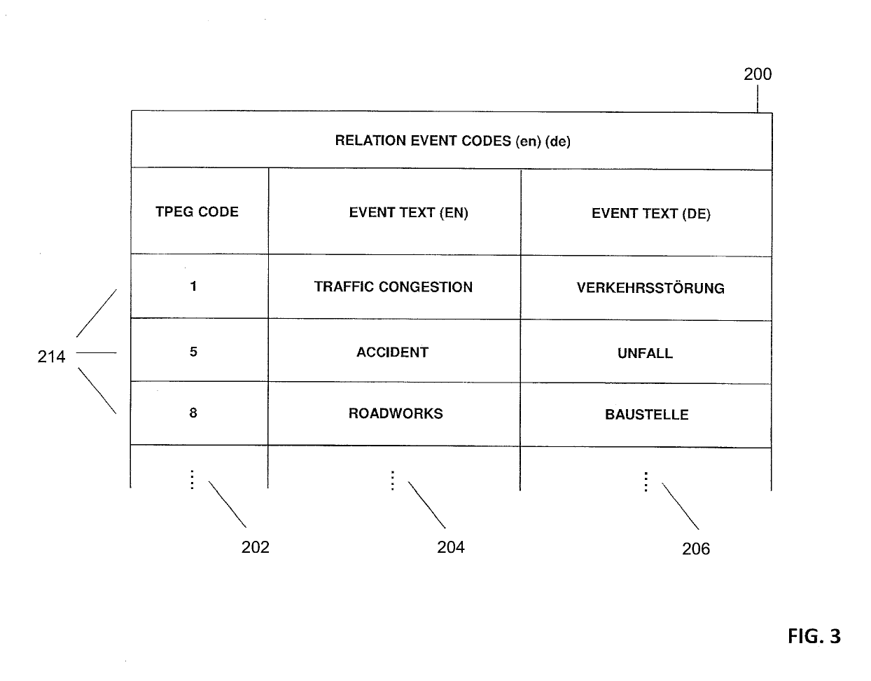

Further possibilities exist for storing event texts for different languages in association with the respective TPEG event code in the relational database 114. FIG. 3 illustrates one example in which the relation 200 stored in the relational database 114 has for each TPEG event code 202 a further attribute 206 for the event text in the additional language. As a result, each record 214 associates a TPEG event code with the event text in two different languages, English (en) and German (de) in the present example. It should be clear that it is possible to add further attributes for associating the TPEG event codes with the corresponding event texts in further languages. With the example of FIG. 3, the event texts for a plurality of languages can be stored within only one relation 200. For a given TPEG event code, the event texts for different languages can be accessed easily and quickly.

Another possible configuration of the database 114 is shown in FIG. 4A. The relation 200 includes, for the same TPEG event code, plural records with event texts in different languages. In order to identify the language in which the event text is provided in a particular entry, a further attribute 210 is provided in the relation 200. The attribute 210 includes a language identifier in form of a language code. In the example of FIG. 4A, records are provided in relation 200 for the languages English (en), German (de) and French (fr), so that three records exist for each TPEG event code. As the TPEG event code is now no longer unique for a particular record, so that it can no longer be used as a primary key, a further attribute 220 can be provided additionally or instead of attribute 210. Attribute 220 includes a surrogate key uniquely identifying the corresponding record. In the example of FIG. 4A, the surrogate key 220 is assembled on the basis of the TPEG event code and the language code for the respective record, so that it can, instead of the language code, be used to identify the language of the record.

When configuring the database 114 in accordance with the example of FIG. 4A, only a small number of attributes are required even for a plurality of languages. Further, for certain TPEG event codes 202, records can be provided only in one or only in selected languages. As there are no empty fields if for a certain language, no event text is provided for a certain event code, storage space can be saved.

FIG. 4B illustrates a particular implementation of the relation 200 shown in FIG. 4A. The relation 200 of FIG. 4B includes several records for the same event code 202, but for different TPEG-Applications and different code types. The attribute 212 specifies the TPEG application, here for example Traffic Flow and Prediction (TFP) or Traffic Event Compact (TEC). Attribute 214 specifies the code type, in the present example are cause code or effect code. A combination of the attributes 212, 214, 202 and 210 may now be used as a primary key, i.e., the combination TPEG application+code type+TPEG code+language code. Such a primary key can uniquely identify a record in relation 200. Any of the relations illustrated in FIG. 2-4A may include records for the same TPEG event code but different code types or TPEG applications, and accordingly, attributes 212 and/or 214 can be implemented in any of the relations shown in these Figures. In other examples, individual relations may be provided in database 20 for different code types and/or different TPEG applications, and relation 200 of FIG. 4B may thus only include one of the attributes 212 or 214.

As can be seen from the above, several possibilities exist of how the TPEG event codes can be stored in association with the corresponding event texts within the relational database 114. It is self-evident that the features of the examples described above can be combined. As an example, plural relations 200, e.g., for different languages, may be provided in the examples of FIG. 3 and FIG. 4, or the relation 200 of FIG. 2 may have further attributes or further records for further languages.

Now turning back to FIG. 1, retrieval unit 116 can accordingly be adapted to query database 114 not only with a TPEG event code extracted from a received message, but also with a language code in order to receive the event text in the corresponding language. Processing unit 106 can be adapted to determine the language code for querying database 114 in different ways. As a first example, processing unit 106 may receive a user input in accordance with which it determines the language code. TPEG client device 100 may also operate with an operating system running on processing unit 106 and having available a number of different languages, in which information is given out to a user (called display languages herein). TPEG client device 100 presents for example graphical control elements in the display language to a user by means of display 110. The currently set display language may be preconfigured or may be set by a user of the device 100. Processing unit 106 can now be adapted to determine a language code in accordance with the display language currently set, and can query the database 114 with the determined language code.

Accordingly, TPEG client device 100 can automatically retrieve the event text in a language corresponding to the currently used display language. Database 114 thus may comprise the event text in each of the display languages that are provided by TPEG client device 100. As mentioned above with respect to FIGS. 2 to 4, the event texts for the TPEG event codes can be stored in the relational database 114 for the additional languages in form of additional relations 200, additional attributes 206, or additional records 214.

A TPEG message received by receiver unit 102 may include one or more TPEG event codes. Processing unit 106 is configured to assemble a text message from plural TPEG event codes by retrieving the event text for each of the event codes from database 114 and assembling the event texts to the text message. The assembled text message, but also single event texts, can then be provided to a user of TPEG client device 100 on display 110. Accordingly, with the reception of only a small amount of data in form of the TPEG event codes, it is possible to display to the user a complex message comprising comprehensive information, e.g., on the traffic situation. As an example, the message may include the effect code for “slow traffic” and the cause code for “slippery road,” which event texts are retrieved from database 114 and assembled by processing unit 106 to the message “slow traffic due to slippery road.”

In some instances, the received TPEG message may include a TPEG event code for which no record exists in the relational database 114. For this event, the corresponding relation in the relational database 114 may include a default record that associates a default TPEG event code with a default event text. If the received TPEG event code is not found in the relational database 114, the default event text is returned by the database.

The TPEG message received by TPEG client device 100 generally comprises further information that is processed by processing unit 106 and given out by means of display 110. The message can, for example, include location information, such as WGS84 latitude and longitude coordinates or TMC location codes, which may be found by processing unit 106 in map data stored in memory 104, and presented together with current position information on display 110. It may include further location information relating to road number, junction, town name, country name and the like, date and time information, information relating to the severity of the traffic event and the like.

Update unit 118 of TPEG client device 100 is a further functional unit implemented by processing unit 106. Update unit 118 interfaces the update interface 108, by means of which data for updating the relational database 114 can be received. Update interface 108 can be configured differently depending on the implementation of the TPEG client device 100. Update interface 108 may for example be implemented as a wired interface, such as a USB interface, a fire wire interface, an Ethernet interface, and the like, or it may be implemented as a wireless interface, such as a wireless local area network (WLAN) interface, a Bluetooth® interface, a mobile communication interface, an infrared interface or the like.

Through update interface 108, update unit 118 can receive data for updating single event codes and/or event texts, updating all event codes and/or event texts for a particular language, adding new records for new event codes or adding all records for a new language. It should be noted that these are only a few examples of the possibilities of updating the relational database 114 by update data received on the interface 108.

Update unit 118 is configured to add or modify the records and the relations of the relational database 114 in accordance with the update data received on interface 108. Update unit 118 may, for example, effect the creation of a new relation in the database 114 for a new language, which new relation includes the records associating TPEG event codes and event texts for the new language received with the update data. Update unit 118 may further modify existing relations 200, e.g., by adding or removing attributes, adding or removing records, or by modifying the contents of records. New records for new event codes can thus be added to the database, or the event text for a particular event code can be changed. Update unit 118 can add the data for providing the TPEG messages in a new language by adding a further attribute to an existing relation comprising the event texts in the new language. The new attribute of a record with a TPEG event code for which no event text is provided in the new language may be left blank. Besides adding new attributes for new languages, as explained above with respect to FIG. 3, new records may be added for the new language as explained above with respect to FIG. 4. Adding new records for the new language can easily be performed even if there are differences in the event codes provided for the different languages (e.g., some event codes exist only for one language, but not for the other).

TPEG client device 100 may, for example, be implemented as a vehicle navigation device, as a personal navigation device (PND), as a personal digital assistant (PDA), as a mobile communication device, such as a cell phone, a smart phone, and the like, or any other device benefitting from receiving and processing TPEG messages. The implementation as a vehicle navigation device or a PND is particularly useful, as these devices are generally capable of displaying map information to a user, on which the location of a TPEG event can be marked and a corresponding event message can be provided. TPEG client device 100 may include further components that are common to the particular implementation of the device 100. As an example, when implemented as a navigation device, device 100 may include a GPS receiver, while when implemented as a mobile communication device, it may include a mobile transceiver adapted for a communication over a mobile telephone network.

As the relational database 114 is decoupled from the software with which the TPEG client device 100 operates, the event text can easily be updated and the database can be expanded by adding new records for new event codes or even adding the records for a new language. Further, due to the structure of the relational database 114, the sorting of database records, e.g., according to a key, such as the TPEG event code, as well as searching the database for a particular record is facilitated. The decoupling of the software of TPEG client device 100 from the relational database 114 enables an independent updating of both entities, i.e., a database update does not require a software update and vice versa.

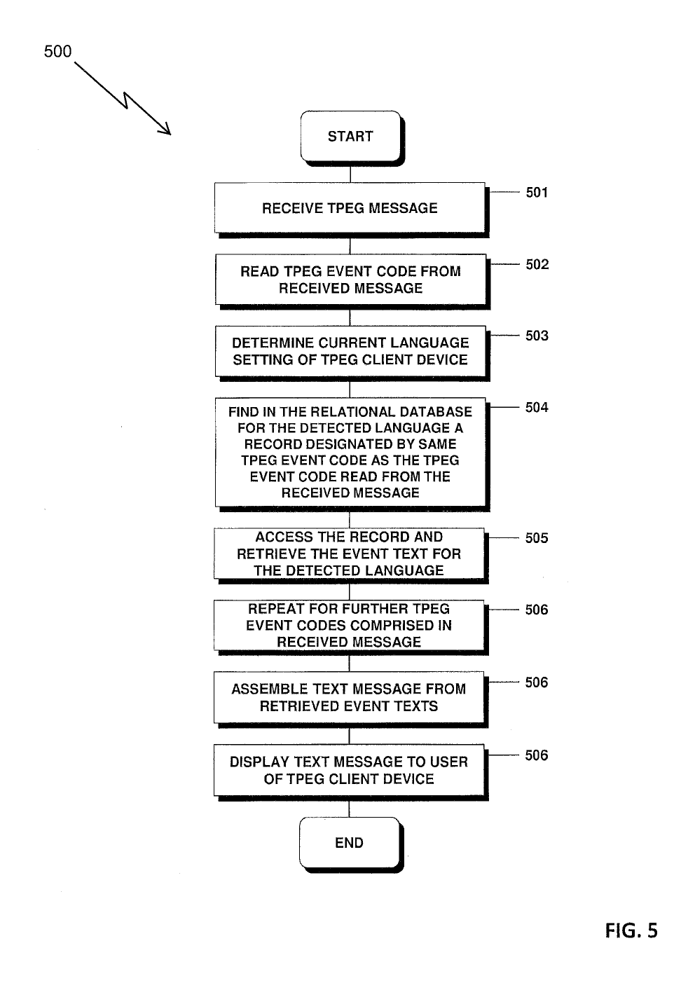

FIG. 5 shows a flow-diagram of one example method 500 for assembling and displaying text messages. The TPEG client device 100 of a FIG. 1 may be adapted to perform the method shown in FIG. 5. In a first step 501, a TPEG message is received. A TPEG event code in the received message is read in step 502. The current language setting of the TPEG client device, i.e., the display language that is currently used by the operating system of the client device, is determined in step 503. Using the corresponding language code and the TPEG event code read from the received message, the relational database is now queried. In step 504, the record for the detected language designated by the same TPEG event code as the TPEG event code read from the received message is found in the relational database. The record is accessed and the event text for the detected language is retrieved in step 505. For the case that the received message includes further TPEG event codes, the steps 504 and 505 are repeated for these further TPEG event codes (step 506). From the retrieved event texts, a text message is assembled in a step 507. In step 508, the assembled text message is displayed to a user of the TPEG client device. The method can be repeated for further received TPEG messages. It is clear that step 503, i.e., the determination of the current language setting only has to be performed once after the initial setting of the display language, or after a change of the current display language. While this and other steps of the method shown in FIG. 5 are optional or may be combined in a single step (e.g., query and retrieval steps 504 and 505), it is clear that the method may include further steps not shown in FIG. 5 and common to the processing of TPEG messages.

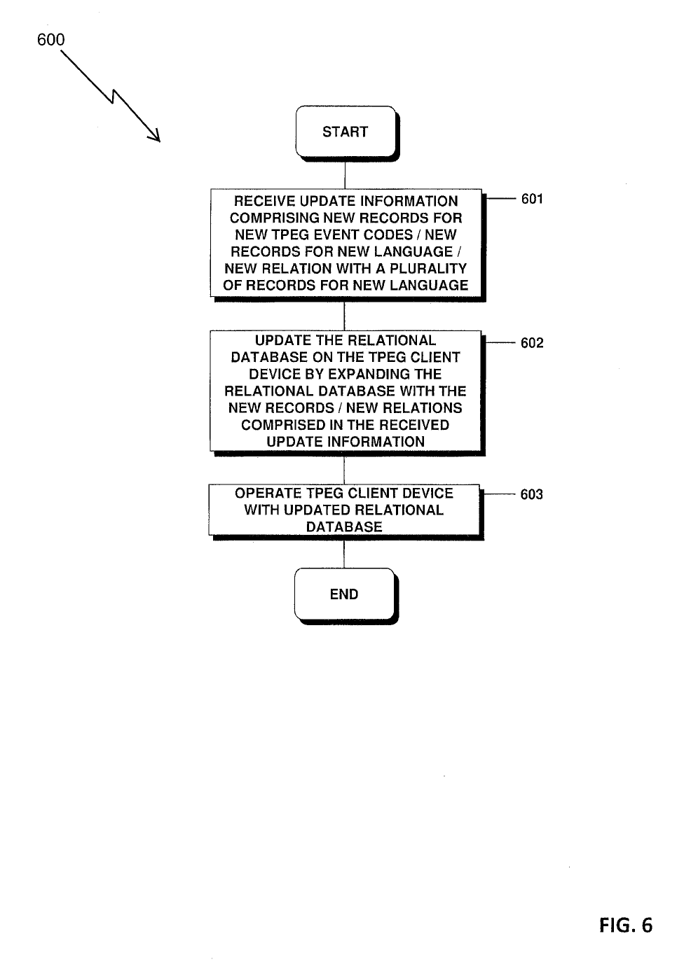

FIG. 6 illustrates an example of a method 600 relating to the updating of the relational database 114 and may again be performed on the TPEG client device 100 shown in FIG. 1. In a first step 601, update information is received, e.g., on update interface 108 (FIG. 1), the update information comprising new records for new TPEG event codes, and/or new records for a new language, and/or one or more new relations with a plurality of records for one or more new languages. In a next step 602, the relational database on the TPEG client device is updated by expanding the relational database with the new records or new relations, respectively comprised in the received update information. Although not explicitly shown in FIG. 6, it is of course also possible to update the relational database by removing records or by removing relations from the database. The TPEG client device is then operated within the updated relational database in step 603. The steps can be repeated every time new update information is received by the TPEG client device.

As seen, a means of storing event texts of the TPEG protocol on TPEG client devices is provided. Storing the event codes and texts in a relational database on the client device may be particularly useful. By means of the database, the association of an event code with a particular event text is decoupled from the software of the client device, so that a later modification of the event text or the addition of new event texts for new languages of the client device is possible without changing the software of the client device.

The electronic device includes an interface adapted to receive TPEG messages having TPEG event codes. The electronic device (or TPEG client device) is provided with a relational database stored in memory. The relational database having at least one relation with a plurality of records, each record associating a TPEG event code with an event text.

By using a relational database for storing the TPEG event code tables, new records for new event codes can be easily added, or the event text for existing records can be easily updated. The use of a relational database can enable the addition of further attributes, further records and further relations, making it feasible to extend the capabilities of the TPEG client device by including further languages. A record can have the TPEG event code as a first attribute and the event text as a second attribute, and may have further attributes, e.g., for explanations, for primary or foreign keys, and the like. The decoupling of the association of the event code with the event text from the software of the client device facilitates the updating and alterations and makes the decoding of TPEG messages more flexible.

According to one example, the event text may be provided as a human understandable text representation describing at least one of a traffic event, an environmental condition or a user information. An event text retrieved from the relational database may thus directly be displayed to a user of the TPEG client device for informing the user about a particular traffic event, such as traffic congestion or roadwork, an environmental condition, such as weather conditions, or user information, such as parking information or fuel price information.

The event text associated with the TPEG event code may be provided in at least a first language and a second language different from the first language in the relational database. The choice can thus be given to the user in which language an event text is given out by the TPEG client device.

As an example, the record of a relation can have the event text in the first language. The record may then have a further attribute with the event text in the second language or the relation may have a further record for the same TPEG event code associating the TPEG event code with the event text in the second language. The relational database may have a second relation with a plurality of records for at least partially the same TPEG event codes in the first relation, with each record of the second relation associating a TPEG event code with an event text in the second language. The relational database accordingly provides a range of possibilities of how further languages can be implemented on the TPEG client device. Providing additional languages by additional attributes in the records has the advantage that the database can be kept compact, as no additional relations are required. Using additional relations for additional languages allows the records of the same language can be kept together in one relation, enabling a simple and straightforward updating or addition of a relation for a particular language.

The electronic device 100 may be configured to operate with at least two different predefined display languages. The event text associated with the TPEG event code may then be provided in the relational database in each of the display languages. In this manner, the TPEG traffic messages can be displayed in the same language in which the TPEG client device is operated. The TPEG client device may, for example, operate with an operating system having a predefined number of languages, and in each of these languages, event texts can be provided in the relational database.

Each record of the relation may further include an attribute with a language identifier that identifies the language of the event text in the record. Accordingly, plural records for the same TPEG event code, but for different languages can be present and identified in the relational database. It is certainly also possible to provide an additional attribute including a surrogate key that may be constructed on the basis of the respective TPEG event code and language identifier, so as to uniquely identify each record of the relation, or to provide the language identifier in form of such a surrogate key.

According to another example, the electronic device 100 may further include a retrieval unit 116 configured to determine a TPEG event code comprised in a TPEG message received on the interface, and to access in the relational database 114 the record having the determined TPEG event code to retrieve the associated event text from the accessed record. By displaying the retrieved event text on a display unit 110 of the TPEG client device, a user of the device 100 can thus be provided with current traffic information in accordance with the received TPEG message. The relation 200 may further include a record for a default TPEG event code associated with a default event text, which can be retrieved from the relational database 114 when no record can be found in the relational database 114 for the TPEG event code received with the message.

The electronic device may further include an update unit 118 configured to modify or add records to the at least one relation of the relational database or to add new relations to the relational database. A record may also be modified by the update unit 118 by adding further attributes to the record. As an example, the update unit 118 can be configured to update the relational database by adding a new record for a new event code or by updating the event text of a record existing for a particular TPEG event code, or by performing language related updates, e.g., updating of all event codes and/or event texts of a particular language, and the like.

The update unit 118 may, for example, be configured to add a further language to the relational database 114 by adding a further attribute having the respective event text in the further language to the existing records, or by adding further records with the TPEG event codes and the associated event texts in the further language to the at least one relation, or by adding a new relation with records with the TPEG event codes and the associated event texts in the further language to the relational database 114. The relational database 114 can accordingly provide a flexible means for enhancing the language versatility of the TPEG client device. The electronic device can be implemented as a vehicle navigation system, a personal navigation device (PND), a personal digital assistant (PDA), or a mobile communication device, such as a mobile phone or a smart phone.

As additionally seen, a method of operating an electronic device 100 configured to operate as a TPEG client is also provided. The electronic device 100 has an interface 108 for receiving TPEG messages and a relational database 114 comprising at least one relation with a plurality of records, each record associating a TPEG event code with an event text. The method includes receiving on the interface 108 a TPEG message having a TPEG event code, accessing in the relational database 114 the record for the TPEG event code corresponding to the TPEG event code in a received TPEG message, and retrieving the event text associated with the TPEG event code from the accessed record of the relational database 114.

The electronic device 100 can be configured to operate with at least two different predefined display languages, and the event text is provided in each of the display languages in the relational database 114. The method may further comprise the steps of identifying the display language in which the electronic device 100 is currently operated and retrieving the event text associated with the TPEG event code from the relational database 114 in the language corresponding to the identified display language. It is accordingly possible to automatically provide the event text to a user of the TPEG client device in a language that was set by the user to operate the device 100.

The method may further include updating the relational database 114 by adding records to or modifying records of the at least one relation of the relational database 114, or by adding a new relation to the relational database 114. A record may also be modified by adding attributes to or removing attributes from the record. This can provide for the addition of event text in further languages, such as display languages of the device, the addition of records for new event codes, the updating of existing records, or the updating of all event codes for a particular language, and the like.

The relational database 114 may be stored on an electronically readable data carrier, where the relational database 114 includes at least one relation with a plurality of records, each record associating a TPEG event code with an event text. The relational database 114 comprised on the electronically readable data carrier may be configured similar to any of the relational databases 114 described above.

It is to be understood that the features mentioned above can be used not only in the respective combinations indicated, but also in other combinations or in isolation, without leaving the scope of the present invention.

It will be understood, and is appreciated by persons skilled in the art, that one or more processes, sub-processes, or process steps described in connection with FIGS. 1-6 may be performed by hardware and/or software. If the process is performed by software, the software may reside in software memory (not shown) in a suitable electronic processing component or system such as, one or more of the functional components or modules schematically depicted in FIGS. 1-6. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. An electronic device configured to operate as a TPEG client, comprising:
an interface adapted to receive TPEG messages comprising TPEG event codes;
a memory; and
a relational database stored in the memory, the relational database including at least one relation with a plurality of records, each record associating a TPEG event code with an event text.

2. The electronic device of claim 1, where the event text is a human understandable text representation describing at least one of: (a) a traffic event, (b) an environmental condition, or (c) user information.

3. The electronic device of claim 2, where the event text associated with the TPEG event code is provided in at least a first language and a second language different from the first language in the relational database.

4. The electronic device of claim 3, where the record of the at least one relation provides the event text in the first language, and where the record has a further attribute with the event text in the second language.

5. The electronic device of claim 3, where the record of the at least one relation provides the event text in the first language, and where the relation has a further record for the same TPEG event code associating the TPEG event code with the event text in the second language.

6. The electronic device of claim 3, where the record of the at least one relation provides the event text in the first language, and where the relational database includes at least a second relation with a plurality of records for at least partially the same TPEG event codes in the first relation, each record of the second relation associating a TPEG event code with an event text in the second language.

7. The electronic device of claim 3, where the electronic device is configured to operate with at least two different predefined display languages, and where the event text associated with the TPEG event code is provided in each of the display languages in the relational database.

8. The electronic device of claim 7, where each record of the at least one relation further comprises an attribute with a language identifier which identifies the language of the event text comprised in the record.

9. The electronic device of claim 7, further comprising a retrieval unit configured to determine a TPEG event code in a TPEG message received on the interface, the retrieval unit configured to access in the relational database the record having the determined TPEG event code in order to retrieve the associated event text from the accessed record.

10. The electronic device of claim 7, further comprising an update unit configured to modify or add records to the at least one relation of the relational database or to add new relations to the relational database.

11. The electronic device of claim 10, where the update unit is further configured to add a further language to the relational database by adding a further attribute comprising the event text in the further language to the existing records, and where adding the further language is performed by either:
adding further records having the TPEG event codes and the associated event texts in the further language to the at least one relation, or
adding a new relation with records having the TPEG event codes and the associated event texts in the further language to the relational database.

12. The electronic device of claim 7, where the electronic device is a vehicle navigation system, a personal navigation device, a personal digital assistant or a mobile communication device.

13. A method of operating an electronic device configured to operate as a TPEG client, comprising:
using the electronic device, wherein the electronic device includes an interface for receiving TPEG messages and a relational database including at least one relation with a plurality of records, each record associating a TPEG event code with an event text;
receiving on the interface a TPEG message having a TPEG event code;
accessing in the relational database the record for the TPEG event code corresponding to the TPEG event code in the received TPEG message; and
retrieving the event text associated with the TPEG event code from the accessed record of the relational database.

14. The method of claim 13, where the electronic device is configured to operate with at least two different predefined display languages, and where the event text is provided in each of the display languages in the relational database, the method further comprising:
identifying the display language in which the electronic device is currently operated; and
retrieving the event text associated with the TPEG event code from the relational database in the language corresponding to the identified display language.

15. The method of claim 14, further comprising updating the relational database by adding records to the at least one relation of the relational database.

16. The method of claim 14, further comprising updating the relational database by modifying records of the at least one relation of the relational database.

17. The method of claim 14, further comprising updating the relational database by adding a new relation to the relational database.
